(19) United States
(12) Patent Application Publication
(10) Pub. No.: US 2018/0053188 A1
(43) Pub. Date: Feb. 22, 2018

(54) CUSTOMER TRANSACTION BEHAVIORAL ARCHETYPE ANALYTICS FOR CNP MERCHANT TRANSACTION FRAUD DETECTION

(71) Applicant: FAIR ISAAC CORPORATION, San Jose, CA (US)

(72) Inventors: Scott Michael Zoldi, San Diego, CA (US); Heming Xu, San Diego, CA (US)

(21) Appl. No.: 15/239,657

(22) Filed: Aug. 17, 2016

(51) Int. Cl. G06Q 20/40; G06F 17/30; G06Q 20/10

(52) U.S. Cl. CPC G06Q 20/4016; G06Q 20/102; G06F 17/30598

(57) ABSTRACT

This document describes detecting fraudulent and anomalous behavior of payment cards. A process includes extracting characteristics from a transaction dataset to generate words and documents associated with payment cards, executing a topic model to obtain the respective probabilities of appearance of a card in each latent archetype, and dividing the card dataset into a plurality of subsets based upon the archetype probability distributions and clustering techniques. The formed subsets are utilized to obtain archetype cluster distribution(s) for each merchant in the dataset. The archetypes are investigated where misalignment with major clusters of archetypes for a merchant may be related to fraudulent transactions. Calculated transaction risks are associated with global archetype cluster membership, merchant-specific archetype cluster membership, and recurrence list positions of transaction details.

### TECHNICAL FIELD

This disclosure relates generally to fraud detection in the transactions. More particularly, this disclosure is related to a computer-implemented method and system for clustering transactions based on the archetypes developed from the Latent Dirichlet Allocation (LDA) model and generating fraud risk assessment based on the archetype membership and the relevant fraud risks associated with archetype clusters associated with a merchant.

### BACKGROUND

Despite the convenience afforded by debit/prepaid and credit cards, transaction security is still a tremendous task. In the financial industry, transactions are monitored by fraud-detection systems to detect fraudsters. The detection systems are generally composed of models that may score the incoming transactions and trigger alerts once certain thresholds are exceeded. The Falcon® model, one of the prominent fraud models, has been successfully developed upon the historical cardholder transaction data for such a purpose.

Understanding the spending patterns of customers is crucial to rapidly detect fraudulent transactions so as to mitigate monetary losses for both card issuers and merchants. The spending patterns are established based upon customer's behavior in the aspects of spending time, merchant location, purchase amount and merchant category code (MCC) etc. The patterns may be extracted from the ever-growing volume of the historical transaction data with a variety of techniques. The cardholder historical data include all the attributes of transactions involving customers and merchants and transaction types etc. One technique is to examine the customer spending history in large databases and then dividing customers into different subsets based on their spending characteristics of transactions. The underlying assumption may be that the consumers in the same subset may have similar behaviors or characteristics. The commonly used algorithms for such a technique include K-means clustering algorithm which divides customers into subgroups using some explicit defined variables in a multiple dimensional feature space.

In commercial practice, businesses wish to identify the characteristics of customers in order to handle the transactions effectively. For different characteristic subgroups of customers, the businesses may appeal to different strategies to enhance their sales in the meanwhile to reduce possible fraud loss. For example, customers make purchases online with plastic cards and some transactions may be not legitimate. Merchant losses occur mainly on the card-not-present (CNP) transactions on the web according to the fraud statistics (e.g., http://www.cardhub.com/edu/credit-debit-card-fraud-statistics/). And the fraud rate for card-not-present transactions is noted to be much higher than for the card-present transactions. For such CNP transactions businesses need to employ extra information on customers to detect fraud and advert the product delivery. Merchants are particularly at a disadvantage as they may have very limited transaction data (or none) of card holders that are transacting at their site, in contrast to the transaction volume/knowledge that the issuers of these payment cards hold. Thus it is beneficial for businesses to mine and analyze the characteristics of customers to share concise behavioral patterns in the form of archetype distributions of customer's behavior in an accumulated dataset in order to better target marketing offers, fine tune market communications or identify best positioning strategy.

By sharing archetype distributions of customers that visit merchants the merchant has an opportunity to understand in this archetype space what are the typical archetype loadings of customers that transact with them, and when possible and also associate fraud and non-fraud outcomes to develop insight and models. These archetype distributions form a concise historical summary and those that are relevant to the merchant as he sees at the time of transactions at his storefront. For example, in some defined subset, a business may have some existing good customers and thus it is highly likely the other customers may have similar characteristics as the existing good customers and hence may be potential non-fraud customers to the business. In this context, relationship with customers and profiling customers becomes of paramount importance in the point of views of merchants.

### SUMMARY

The current subject matter describes a method and system of detecting frauds and anomalous behavior of payment cards. The procedures include extracting characteristics from a transaction dataset to generate words and documents associated with payment cards, executing a topic model to obtain the respective probabilities of appearance of a card (its transactions form a document) in each latent archetype, dividing the card dataset into a plurality of subsets based upon the archetype probability distributions and clustering techniques. The formed subsets are further utilized to obtain the archetype cluster distribution(s) for each merchant in the dataset. The archetypes are investigated where misalignment with the major clusters of archetypes for a merchant are related to fraudulent transactions. The relationship between the archetype clusters and fraudulent activity may be utilized to estimate the transaction fraud risks associated with new transactions whose archetype membership may be determined based on the overall card transaction history characteristics across a multitude of merchants. The method incorporates the characteristics of both the overall archetype cluster distributions at the card issuer or processor level or global level and the archetype modal distributions at the local merchant level. The method and implementation system are capable of assessing risks in CNP transactions for the purpose of identifying frauds to reduce the monetary loss for merchants, particularly merchants with limited or no transaction history with the cardholder.

In certain aspects and variations thereof, a method and system for detecting fraud include executing a processing that includes receiving, during a card-not-present (CNP) online transaction conducted over a communications network, data representing a new transaction from a customer's payment card. The process further includes associating the customer with an archetype distribution stored in an electronic database, the archetype distribution being generated by an archetype calculation engine based on past transactions across a plurality of merchants by the customer and customer attributes and computed by an issuer or processor of the customer's payment card. The process further includes generating a topic model based on one or more words and/or one or more documents selected from the data representing the new transaction and the past transactions, the topic model representing a similarity of the words and/or documents of the new transaction with words and/or documents in the past transactions represented by the archetypes. The process further includes generating archetype clusters based on the archetype distribution vectors for each document upon execution of a topic model, the archetype clusters representing a similarity of documents in the archetype space based on past transactions by the customer and customer attributes.

The process further includes associating the customer with an archetype cluster generated by the archetype cluster calculation engine based on data representing the past transactions from the customer or one or more other customers, the archetype cluster representing a distribution of a probability of attributes related to each of the past transactions at the merchant. The process further includes locating, from the electronic database, an archetype distribution vector and archetype cluster generated by the archetype calculation engine based on data representing the past transactions from the customer or one or more other customers, the archetype cluster representing a distribution of a probability of attributes related to each of the past transactions at a multitude of merchants, the archetype distribution vector representing the current archetype distribution of the customer's transactions across a multitude of merchants. The process further includes generating, in near real time to the CNP transaction, a score representing a likelihood of fraud associated with the new transaction based on the calculated transaction risks associated with global archetype cluster membership, merchant-specific archetype cluster membership, and recurrence list positions of transaction details.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a block diagram of a Latent Dirichlet Allocation archetype model build

FIG. 2 shows an exemplary distribution of archetype for a PAN.

FIG. 3 illustrates an exemplary archetype cluster distribution from a dataset.

FIG. 4 shows illustrative archetype cluster distributions in two merchants.

FIG. 5 shows exemplary archetype cluster distribution and fraud rate of one merchant.

FIGS. 6 (a) and (b) depict the relationship between archetype cluster proportions and fraud rates for overall dataset.

FIG. 7 is a block diagram of a system showing the structure of a transaction data processing.

FIG. 8 is a block diagram of online operation.

When practical, similar reference numbers denote similar structures, features, or elements.

### DETAILED DESCRIPTION

This document describes a method and system of detecting frauds and anomalous behavior of payment cards. In the present disclosure, a technique called Latent Dirichlet Allocation (LDA) method is uniquely employed to the financial services industry to divide customers into a number of subsets based on clusters of customers based on their archetype distributions which are computed based on the spending behaviors such as MCC, spending amount, location etc., for the cardholder's transaction dataset. The spending pattern is thus built from the LDA training with associations between customers (card holders) and archetypes. The archetype distribution and fraud activities in each archetype provide vital information on customers' spending patterns. For individual merchants, the spending pattern may be extracted in the form of the archetype distribution for cardholders shared by issuers at the time of transaction at the merchant site and applied to new transactions to assess the transaction risk from customers that have been categorized into different archetypes. In this sense the archetype distribution represents a concise compact representation of the transaction history known by the issuer.

The present disclosure presents a system and method to assess merchant transaction fraud risks associated with individual customers from archetypes using a topic model and archetype clusters. A topic model is first built on an accumulated training dataset of the cardholders, generating the document (PAN)-topic probability matrix. And then the training dataset is grouped into subsets based on the archetype probability vectors of the accounts (i.e., PANs). Each subgroup (subset) contains PANs which are closely associated with a single archetype cluster and have a high degree of similarity between customers inside the same subset in the archetype feature space. More generally cards that share a similar distribution in the archetype distribution are related in transaction history and to the extent these distributions match major clusters of activity at a merchant can be used to asses fraud and nonfraud risk. For merchants, which share the cluster distribution of customers with the card issuers or card processors, the archetype cluster distribution is thus generated as a reference to incoming transactions from the historical data. The fraud rates may be obtained for each archetype cluster as well in case the tags are complete in the dataset. The new transactions are evaluated by identifying the archetype cluster that their PANs belong to, and then comparing with the reference archetype cluster distribution. The transaction risks are scored based on the archetype clusters associated with the transaction and their distribution characteristics. On the other hand, for existing customers making multiple purchases in a given period, transaction risks may be estimated based on the length of the history of card on file, history of IP addresses, frequency of the purchase items and shipping addresses as well using the BUST technology, as described in U.S. Patent Publication No. 2010/0228580, entitled “Fraud Detection Based Efficient Frequent-Behavior Lists,” the contents of which are hereby incorporated by reference for all purposes. The system implementing this method is capable of operating in real time to assess risks of transactions.

Card transactions may be characterized with features or attributes such as transaction date, time, amount, location, merchant category etc. These raw features of transactions may be directly utilized in model development. In general, features from the raw variables are frequently transformed into other variables in order to effectively reveal the fraudulent characteristics. Those derived (transformed) variables may be mingled with the raw variables to form a feature set. It should be noted that not all the features have the same significance in contributing to the classification capability and thus only a limited and practical pool of features may be used in the model construction. In addition, in some embodiments, business knowledge may also be considered in the procedure of selecting final variables.

In one or more embodiments, a process includes two phases: a training phase and a testing phase. For example the historical transactions may be used in the training phase to build a machine learning model. Thus the machine learning model is data-driven. In the testing phase, the transactions in the given testing dataset are fed into the built machine learning model. The characteristic for each new transaction is predicted based on the features in the current transaction. Note a score for each new transaction is predicted based on the features in the current transaction and compared to the actual classes if available, as they appear in the testing dataset, which is subsequently represented in an accuracy measure to assess the performance of the built learning model. In commercial practice, the training phase includes building a predictive model using historical transactions and the testing phase involves the operational stage at which the model is installed to monitor all the incoming transactions.

It should be understood that the individual features of transaction include merchant category code, location, amount etc. These individual entities can represent various facades of the observed transaction data. Sometimes an aggregate of those individual features may provide some important insights that may be not shown in individual feature space. In practice both the individual and aggregate features may be utilized. In analogy with the document processing in a topic model building, these features or attributes pertaining to a transaction may be referred to as “words”. The generated words can be categorical. Continuous features such as amounts may be discretized into categorical type. In such a way each transaction is transformed into a word that represents the transaction in a model.

Moreover, a transaction is performed by a client using the account. The account may be characterized with a primary account number (PAN) which is unique across all the accounts. The account (PAN) may be referred to as “document” which holds numerous “words’ that characterizes observed historical transaction data such as transaction amount, date, MCC or some aggregate entities, etc. With “word” and “document” defined for each transaction and PAN, the frequency of words appearing in the documents may be revealing the intrinsic transaction patterns. After this transformation from raw features to “bags of words” for each transaction, a topic model can be built for transaction dataset indexed on PAN.

Topic models are a preferred approach for representing the content of documents and retrieving information from the documents related to some topics. For example, LDA model or a similar generative model, produces a probability distribution of topic membership for each document within a group of content which can be treated as a vector (It should be noted that the “topic” and “archetype” are used interchangeably hereafter). The probability distribution represents the strength of the revealed association between a topic and a document. Some assumptions underlying LDA models may include that documents are represented as random mixture over latent topics, where each topic is characterized by a distribution over words; a plurality of topics/archetypes are included in the document set; and the frequency of appearance of a word included in a document results from a topic (archetype) included in the document set. The archetypes may be estimated from a large dataset using a topic model (e.g., LDA model), and represent abstraction of generally correlated behavior, thus the LDA model may assist in learning the intrinsic structure from the dataset and thus the cardholders' spending behaviors.

Each document (for example PAN) represents a data point in a dataset that can be subset by a subsetting algorithm. PAN subsetting procedure aims to group PANs into subsets such that PANs belonging to the same group have a high degree of similarity. A topic model like the LDA model identifies a fixed number of latent topics (archetypes) in a collection of documents (where the document is a history of words associated with the PAN) based on similarity of word distributions of the documents and explains sets of observations regarding data similarity with unobserved groups. It is a probability generation model and can be applied to identify latent topic information in a large-size document set. The LDA model utilizes a bag of words method in which each document is regarded as word frequency vector so that document information is transformed into a numerical representation of a distribution over archetypes that can be conveniently modeled. Upon execution of the LDA model, each document represents a probability distribution formed by some topics (that is a mixed membership in all the topics) and each topic represents a probability distribution formed by many words over many PANs. The probability of a PAN over archetypes may be seen as the strength of association between an archetype and a document (or word). Such obtained topics can capture concepts and general behaviors associated with the set of documents, resulting in clustering of the documents (PANs). In this manner, all PANs are thus classified into a given number of archetypes based on their historical transactions.

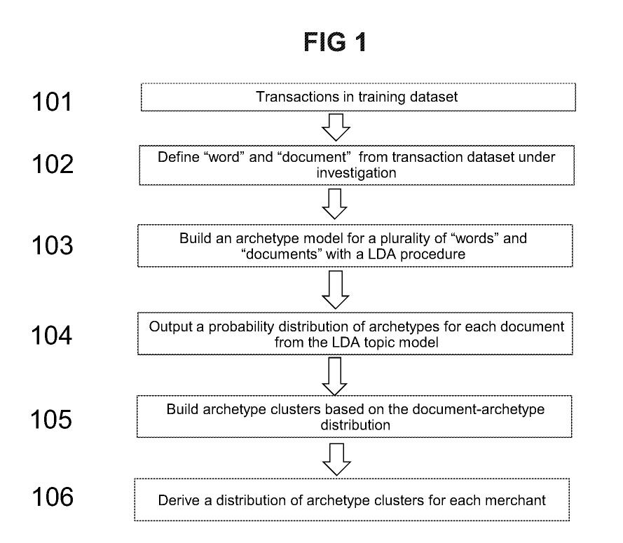

FIG. 1 is a block diagram of building a topic model from a transaction dataset 101 according to some implementations. Each transaction is characterized by the so called “word”, basic entities associated with a transaction, such as transaction date, time, amount, merchant category code (MCC), location etc. All the “words” from same card (PAN) form a “document”. Therefore PAN refers to the document. First “word” and “document” may be defined for the transaction dataset 101. Single entity like MCC or location may be selected as words to track the activities of each PAN such that a MCC or location to train a Latent Dirichlet Allocation model. Also an aggregated quantity may be utilized such as MCC-location, MCC-amount, etc. Such combinations may reduce the number of words so as to make it feasible to train an LDA model. Since some entities may be continuous, it can be binned into discrete entities for processing. Selections of designations of “word” and “document” may be determined based on the dataset under investigations or some business needs. The words and documents are defined in block 102 and now the transaction dataset has been transformed into a set of discrete entities, that is, each document (PAN) corresponds to a bag of words from all the transactions with the PAN.

Referring still to FIG. 1, a Latent Dirichlet Allocation (LDA) is trained with the above document-word dataset in block 103. The number of topics is predefined a priori for the dataset under investigation. Each word in the collection of documents has a probability of being related to each of the latent topics. Given the collection, LDA learns the probability that each word of the collection related to each latent topic and the probability that a document in the collection relates to each topic. Upon execution of LDA, the LDA model thus generates a matrix describing the topic probability distribution for each PAN in block 104. It should be noted that after execution of LDA, not all the PANs have similar activity patterns and the PAN's archetype distribution will differ.

The obtained document-archetype probability distribution from the LDA model illustrates the intrinsic structure of the underlying dataset in terms of the choice of documents and words. Those skilled in the art may find a variety of ways to define documents and words based on the business need and the number of archetypes may be optimized by some iterative process, and thus the resulting probability distribution matrix may illustrate different structures of the underlying dataset.

The document (PAN) is related to each archetype with a probability or strength of association. It is recalled that the characteristics of transactions may include transaction time, transaction geographical location and merchant identification. The archetype distribution may be informative to merchants (businesses) since the businesses may wish to collect the information of their customers at the time that these customers transact with them. Merchants typically have very limited transaction data for individual PANs. By sharing an archetype distribution at the time of transactions at the merchant site which have been categorized by the above LDA archetypes the merchant can learn the typical archetype distributions and clusters of customers and where fraud and non-fraud outcomes exist merchants may build models based on these archetype distributions and correlations with modes of archetypes. For example one business may have a dominant archetype cluster in its customer database and these customers in the same archetype may have similar spending behaviors. Such customer information may be vital for fraud detection.

Each document (PAN) has thus a distribution of probability over archetypes obtained by virtue of the above method. The distribution may be represented as a vector of which the components correspond to the probability at each archetype. In order to characterize the spending pattern of PANs, the probability vectors may be used to divide the dataset into virtual communities of PANs such that all of the PANs in a given community are related. One commonly used method to group data is K-means method. Other clustering techniques may be used as well. All the PANs are represented data points in a feature space which is defined by the corresponding archetype probabilities. For example if there are 50 archetypes involved, the PANs would be clustered in the 50-dimensional feature space. The cluster construction is performed in block 105 and hence the dataset may be represented by a set of clusters determined by the distribution of the archetypes. This distribution analysis can be done globally or performed only on PAN archetype distributions at the type of merchant transactions and the clusters are specific to merchant transactions.

Such a procedure generates a global distribution of archetype clusters at the card issuer level or the card processor level, providing a large-scale characteristic of transactions involving all the PANs. Note that a PAN may transact in various merchants, locations etc. To characterize the transactions at each merchant of specialty, the distribution of clusters may be shared between card issuer/processor and merchants since individual merchants cannot see a lot of PANs so that merchants have a limited capability of intelligently mining and analyzing customer's behaviors. Such sharing may enable each merchant to collect and analyze the cluster distribution for only the PANs that transact at the merchant. In general each merchant involves only a small portion of customers (PANs) so that the global information (transactions in other merchants, and history knowledge of the PANs etc.) of the PANs is vital to each merchant to characterize the PAN at transacting at the merchant. Without a doubt the cluster distributions may vary from merchant to merchant and the characteristics of the distribution are fully dependent upon the factors such as business category, location etc. so that the merchant level cluster distributions may be valuable for individual merchants. Namely some specialized merchants may only attract certain clusters of archetypes of customers while some general stores may have a wider spectrum of archetypes seen in their customer population. Certainly the archetype cluster distribution may change with time when the LDA training is periodically performed with new dataset. With such information extracted from the dataset the business may develop strategies to accurately target potential fraud in its customer base.

Main methods that the Latent Dirichlet Allocation model is trained with include a variable expectation maximum (EM) based algorithm, a Gibbs sampling-based algorithm and an expectation-propagation algorithm. In some implementations, it is assumed that the variable EM algorithm is adopted but not limited to the variable EM algorithm. All those topic methods yield matrices of the document-topic and word-archetype as outcome for profiling customers below.

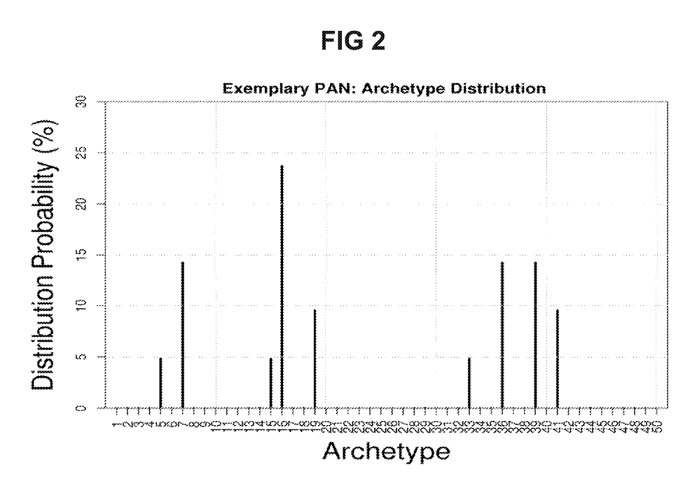

For each document (PAN) it has been mentioned that the archetypes are not uniformly distributed since customers may not have same degree of interest or need in all purchase categories. That distribution may be consistent with the spending behavior of customers and is thus insightful for assessment of the fraud risk. For example, some customers may shop a lot for luxury items and others may travel a lot. The archetype distributions may exhibit different features according to the spending behaviors. FIG. 2 illustrates an example of archetype distribution for a PAN (customer) with 50 archetypes. The number of archetypes may be determined by the business need. In such an example the distribution exhibits non-zero values in 9 archetypes but are zeros in rest of the archetype, due to the complexities of the heterogeneous spending behavior. The archetypes are further aggregated into clusters below.

In one or more implementations, the archetype probability is represented as an archetype vector for each PAN such that each PAN corresponds to a data point in an N-dimensional feature space. N is the number of archetypes and the features are the archetypes upon execution of a topic model like LDA. For example, for a 3-archetype case, a PAN may have probabilities of 0.32, 0.4, 0.28 in the 3 archetypes so the probability vector may be written as (0.32, 0.4, 0.28), which may be regarded as a data point in a 3-dimensional feature space. The archetype distribution in FIG. 2 can be represented by 9 non-zero components in the 50-dimensional archetype space. By way of representing each PAN with an archetype vector, the entire dataset is thus transformed into a distribution of PANs in the archetype feature space. The characteristics of the transactions may be exhibited in the archetype space from which a clustering algorithm may apply to identify clusters of the archetypes. A commonly used method is K-means method and other methods may be applied as well.

Clustering is performed on the entire dataset using the Euclidean distance between the archetype vectors and thus virtually divides the transaction dataset (document set) into n small subsets of a plurality of documents with each small set which are highly similar to each other in the archetype feature space. Such formed subsets are certainly mutually exclusive in the sense that one PAN cannot be categorized into more than one cluster. It should be noted that the archetype-document probability distribution is seemingly heterogeneous such that the corollary is that subsets (by archetype cluster) may have varied numbers of PANs in the subsets.

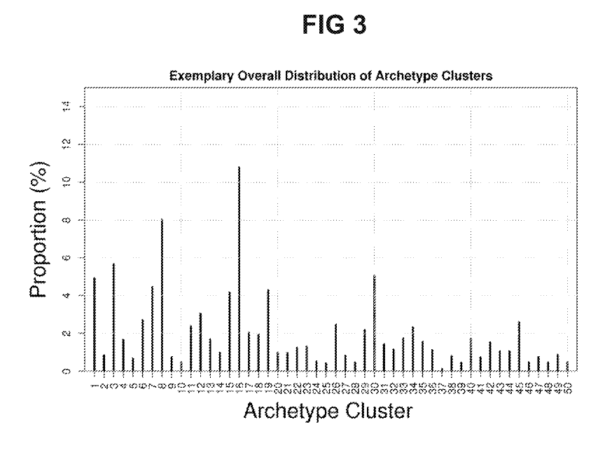

An exemplary distribution of archetype clusters is illustrated in FIG. 3 for the entire dataset. The horizontal axis denotes the cluster number and the vertical axis denotes the population of PANs in each archetype cluster. It is known that the clusters are formed utilizing the archetype vectors for PANs and each PAN may have different components in those vectors. The distribution may show multi-modal characteristics which may depict dominant clusters in all the PANs at the card issuer level or processor level (i.e., on a global scale).

This figure demonstrates that the distribution may be heterogeneous in the sense that this distribution may have favorable proportions at archetypes clusters 16, 8, 3 with saliently higher percentage in the overall dataset but has lower proportions at rest of the archetype spectrum. The appearance of the distribution is fully determined by the customer spending behavior extracted from the underlying transaction dataset, the selection of the definitions of documents and words utilized in the LDA training and number of archetypes and number of clusters chosen a priori. Those skilled in the art may be not difficult to obtain different sets of distributions of archetypes which are completely pertinent to the underlying design of the model on the available dataset.

On the global scale the card issuer or processor obtains the distribution of archetype clusters of all the PANs transacting at merchants. It is understood that each document (PAN) in a subset may contain a plurality of transaction attributes such as different times, locations, amounts, merchant category codes (MCCs), merchant, etc. The resulting subsets of archetype clusters using the LDA model certainly augment the attribute to each PAN with its archetype information in addition to the original transaction attributes or features. The dataset is thus cast as having one more dimensional dataset with the archetype cluster attribute attached to each PAN. Those skilled in the art may find it is useful to utilize the additional information in profiling customers to better understand customers' spending characteristics.

In the above formed subsets in which each PAN corresponds to one archetype cluster, it is noted that the customer associated with a PAN may visit a variety of merchants, i.e., each PAN may contain transactions in many merchants. On the other hand, each merchant in the transaction dataset may correspond to many PANs. Hence, the relationship between PAN and merchant is a many-to-many relationship. Table 1 shows an illustrative relationship between PAN, archetype cluster and merchant visit times. In this table, PAN 1 belongs to archetype cluster 2 and make 4 purchases in merchant 1 and 12 purchases in merchant 2; PAN 2 belongs to archetype cluster 1 and make 20 purchases in merchant 1 and 0 purchases in merchant 2; and so on. The last column in Table 1 indicates the target class of the PAN, that is, whether this PAN corresponds to a nonfraund or fraud account.

Table 1 Illustrative relationship between PAN, archetype cluster and visits in different merchants in a period:

TABLE 1

| | | | Archetype | |
|---|---|---|---|---|
| PAN | Visits in | Visits in | cluster | |
| (customer) | Merchant 1 | Merchant 2 | membership | Target class |
| PAN 1 | 4 | 12 | 2 | Nonfraud |
| (customer 1) | | | | |
| PAN 2 | 20 | 0 | 1 | Nonfraud |
| (customer 2) | | | | |
| PAN 3 | 5 | 5 | 10 | fraud |
| (customer 3) | | | | |
| PAN 4 | 1 | 3 | 2 | Nonfraud |
| (customer 4) | | | | |
| PAN 5 | 5 | 5 | 3 | Nonfraud |
| (customer 5) | | | | |
| PAN 6 | 5 | 3 | 2 | fraud |
| (customer 6) | | | | |
| TOTAL | 40 | 28 | | |

From the standpoint of a merchant, those PANs may correspond to archetype clusters since the PAN and archetype cluster are one-to-one relationship based on the above LDA model and clustering based on the archetype-PAN probability vector. Each customer may be accordingly labeled or identified with one archetype cluster. The merchant may see some or all of the archetype clusters dependent on the transactions at this merchant in the dataset. Note that these archetype clusters are associated with the customer's spending patterns (derived from the LDA model) and similarity between customers. Merchants may utilize the distribution of the customers' cluster membership, which are characterized at the card issuers or processor and shared down to the merchant level, to analyze behavior of the customers who visit such a merchant. Such two-level composite approach is important to thoroughly mine the characteristics of customers, especially for CNP merchants who suffer higher fraud rates and where merchants have correspondingly little historical data often on the purchasers.

Referring to Table 1, merchant 1 sees all the customers 1-6 (i.e., PANs 1-6), whereas merchant 2 sees all the customers but customer 2, i.e., customer 2 does not have relationship with merchant 2. A simple calculation may produce a distribution of archetype clusters for each merchant from the customer visits. For example, for merchant 1, the proportion distribution is (4+1+5)/40 with archetype cluster 2, 20/40 with archetype cluster 1, 5/40 with archetype cluster 10 and 5/40 with archetype cluster 3. The proportions are obviously non-uniformly distributed across archetype clusters: merchant 1 has the largest proportion values at archetype cluster 1 (e.g., merchant 1 sees more customers from archetype cluster 1 than any other 3 archetypes in such a case) and merchant 2 has the largest proportion value at archetype cluster 2. The proportions of archetype clusters in a merchant may be represented as a vector such as:

mᵢ=(Aᵢ₁,Aᵢ₂, . . . ,A_{iN}) and subject to Σⱼ₌₁^{N}Aᵢⱼ=1

Where i ranges from 1 to total number of merchants and N indicates the total number of archetype clusters. Aᵢⱼ is the proportion (in percentage) of jth archetype cluster in merchant indexed by i, calculated by dividing the total visit times at each archetype cluster by the total customer visit times per merchant.

The above designation of archetype clusters for each customer (PAN) employs a K-means method, for example, to cluster PANs in the archetype feature space such that each PAN is assigned to only one cluster. For an individual merchant, the distribution of archetype clusters described is solely obtained by counting the numbers of archetype clusters from all the customers transacting in the merchant. Those skilled in the art may find it useful to utilize a fuzzy approach to describe the PAN distribution in the archetype space, for example, using a fuzzy K-means method. In this scenario, each PAN may associate with each archetype cluster with a different probability, and this probability may be taken into account when counting the merchant visits by each PAN. Still referring to Table 1. Those having skill in the art may find that the membership probabilities may be utilized when calculating the archetype cluster distributions for each merchant. For example the purchase counts M by a customer may be multiplied by the membership probability p to obtain the total count at each merchant, that is:

Count at each archetype cluster=Σᵢ₌₁^{K}MᵢPᵢ

where K is total number of customers transacting with the merchant, and i indicates the ith customer. For example referring to Table 1 the contribution of PAN 2 to the count at archetype cluster 1 may be obtained as 20*membership at cluster. The same process may apply to all other customers (PANs) and the overall contribution may be calculated with the fuzzy membership. The resulting distribution calculated in such a manner indicates contributions from weightings by individual membership probability.

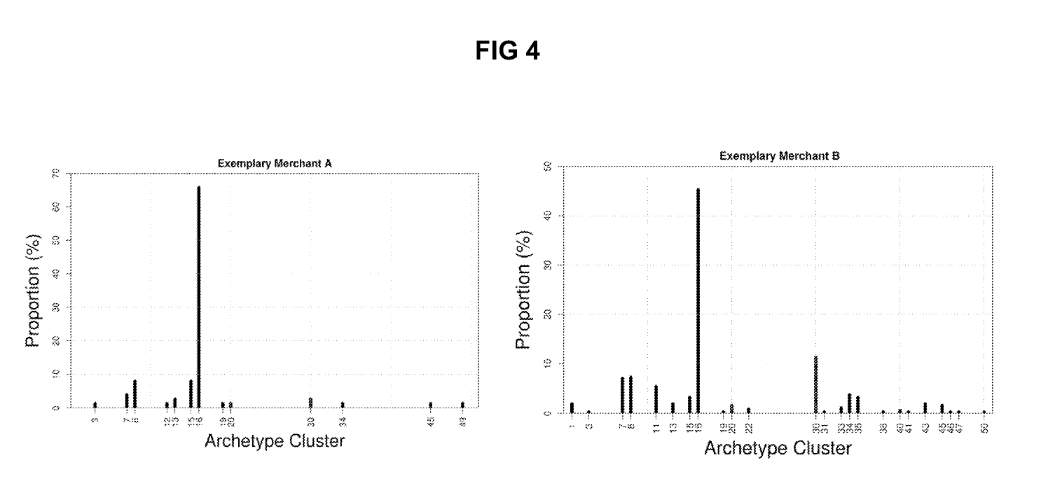

FIG. 4 illustrates the archetype cluster distributions of two exemplary merchants, A and B in the case of 50 archetype clusters. Seen from this figure, both merchants seem to see customers of with contributions in archetype cluster 16, with 66% for merchant A and 46% for merchant B. The cluster 16 may be seen as a main mode in the dataset. The customer's secondary archetypes then cluster with lower proportions and come from archetype cluster 8 and 15 for merchant A, from archetype cluster 30 for merchant B. Different merchants are engaged in different types of businesses of specialty so it is plausible for merchants to exhibit different distribution patterns of archetype clusters in individual customer databases.

In the meanwhile, businesses tend to expand the customer bases by targeted campaigning and offering new products etc., the behavior of those archetypes as groups need to be characterized to have desirable results. If some archetype cluster of PANs has a large volume of fraudulent activities in case the tags are available, the decision to outreach to such an archetype cluster group may be reviewed carefully in order to avoid potential loss. For example for an online merchant, it may wish to assess how risky the transactions conducted by the customers with credit or debit cards are before goods are shipped. The method to identify the possible fraud may include examining the behavior of existing customers and the association with the customer archetypes, which is especially important for an online merchant (CNP transaction) because the fraud risks are well known to be high, on the other hand there is time delay between ordering and shipping to investigate thoroughly the suspicious activity if some alert was triggered.

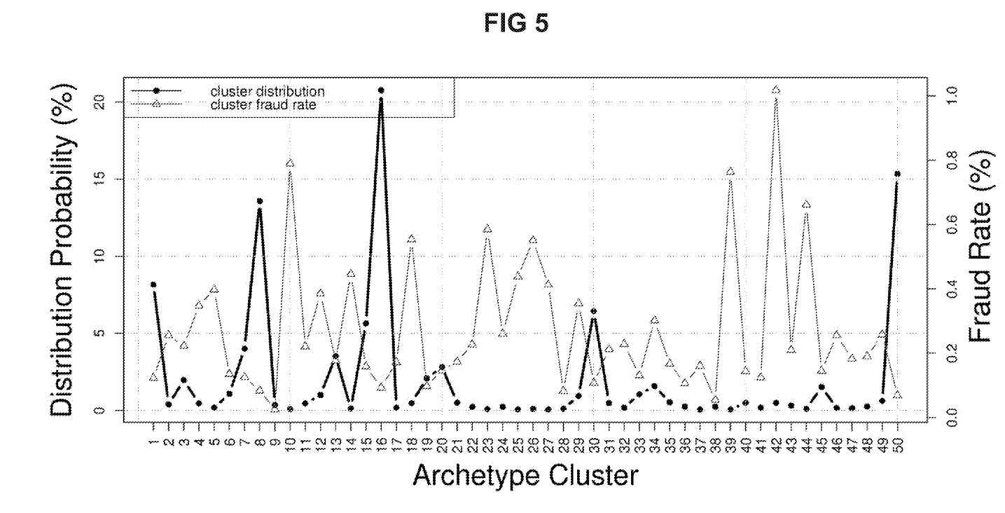

To assess fraud risks with the new transactions, the merchant may want to look into the behavior of the existing customers as a benchmark to determine potential fraud risks. FIG. 5 illustrates a distribution of archetype clusters and fraud rates for one merchant in a transaction dataset. In this example the dataset has all the tags for all the transactions (such as in Table 1). The x-axis is the archetype cluster (50 archetype clusters in this example) and the left y-axis denotes the archetype cluster distribution and the y-axis is the fraud rate distribution. The black circle-line corresponds to the percentage of number of PANs (pertaining to the left Y-axis) belonging to each archetype cluster. The distribution has a peak at archetype cluster 16. The red triangle-line corresponds to fraud rates in each archetype cluster by counting the number (F) of fraud transaction and the number (NF) of legitimate transactions and obtaining the ratio of F/(F+NF). The fraud rate curve (red line) exhibits non-uniform distribution in all the archetype clusters. The archetype cluster percentage and fraud rate in the archetype cluster may be correlated, that is, at higher percentage of archetype cluster distribution (e.g., black line at archetype clusters 8, 16) the fraud rate is very low (red line at archetype clusters 8, 16), whereas at lower percentage of archetype cluster distribution (e.g., black line at archetype clusters 10, 42), the fraud rate is relatively higher than those at the large archetype cluster percentage.

The correlation shown in FIG. 5 is in good agreement with intuition and customer's spending behavior. Customers who are in the same archetype clusters make purchases at a merchant frequently, even they are first time buyer at this merchant, have low fraud rate for the transactions in this merchant; on the contrary customers of some type rarely visit some merchant, the fraud risks may be much higher. Such kind of correlation is a good indicator for a merchant and may be utilized to predict the fraud risks with some customers of an archetype cluster.

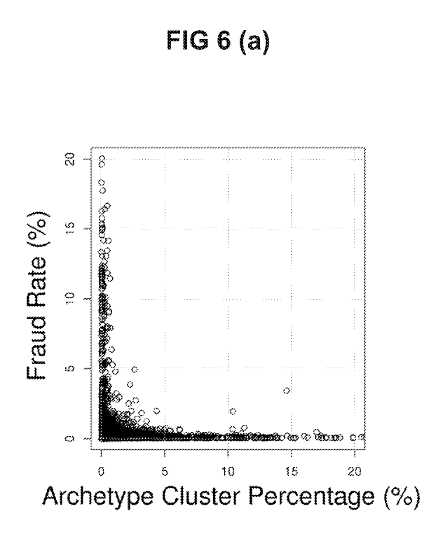

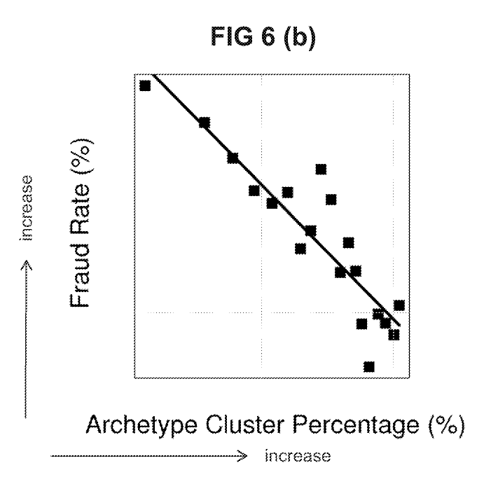

FIG. 6(a) illustrates exemplary overall relationship between fraud rates and archetype cluster distribution from a transaction dataset. The horizontal axis indicates the percentage of archetype cluster for each merchant. It is known that all the PANs in the dataset are labeled with respective archetype clusters based on the clustering method and the percentage of archetype cluster is calculated by dividing number of any archetype clusters by the total number of PANs in each merchant. The fraud rate is thus calculated for each archetype cluster by counting the fraud and nonfraud PANs associated with transactions with a merchant. The general trend in this figure reveals that fraud rates are statistically higher at lower archetype cluster percentage while the fraud rates are much lower at higher archetype cluster percentage. The results of the relationship between fraud rate and archetype cluster percentage are commensurate with the intuition that fraudsters behave abnormally (lower archetype cluster percentage, higher fraud rate), in general distinctly from the normal spending patterns by regular customers of archetypes (higher archetype cluster percentage, lower fraud rate). Frequent visits to a merchant of similar PAN archetype distribution may be denoted as safer transactions according to an embodiment of the present disclosure. For example, in online transactions, a rare purchase of some product by a customer with a unique archetype distribution and rare compared to the merchant clusters of archetypes may pose as a high risk while continuous purchases at a merchant aligned with dominant clusters deem to be legitimate and safe.

It may become more salient when the archetype cluster percentage values are binned into a few groups to obtain conglomerated function of correlation. In each bin of archetype cluster percentage, the total number of nonfraud and fraud PANs in the dataset are obtained to calculate fraud rate in such a bin. The archetype cluster percentage of a bin is the average of all the archetype clusters in this bin range. Such a method may generate a result which is shown in FIG. 6 (b). Such binned fraud rate is seen as a function of archetype cluster percentage. The line in the figure is a linear fit to the data points. So the function of the linear fit may take a form of:

fraud rate=C*(archeptype cluster percentage)^{-K}

Where K is a constant obtained from the linear fit in log space and C is a constant. The K value measures how fast the fraud rate drops as the archetype cluster percentage increases (due to negative power in the above equation). Those skilled in the art may find other functional fits as plausible such as polynomial function etc. And the functional form of the fit certainly depends on the characteristics of the underlying dataset, the LDA training model and clustering method.

Businesses may utilize such correlation information in the decision-making. The risk factor may be obtained using both the archetype cluster percentage value and the functional form for new transactions. Generally the PAN may be located in the transaction data and then transformed into an archetype cluster using the PAN-archetype probability matrix and clustering technique like K-means method. Then the percentage value of the archetype cluster may be found for a given merchant. In accordance with the preferred embodiment, if the archetype cluster of the customer conducting transactions coincides with the archetype clusters of its main customer base with higher archetype cluster percentage (main-mode), the risk associated with the new transaction may be quite low. On the contrary, if the archetype cluster of the customer coincides with the archetype clusters of lowest percentage, the risk may be high. In case transaction tags are available, the fraud risk associated with a new transaction may be qualitatively obtained from the above equation:

fraud rate=function of archetype cluster percentage.

For the online merchants who mostly see card-not-present (CNP) transactions, the method to obtain risks of transactions described above may be quite useful. If the risk is found high, the merchant may initiate more investigations on the transaction. The business process of online merchant with CNP may be different from those of card-present transactions on its nature that there is time delay between ordering and shipping so that the merchant may apply more options to alleviate monetary loss due to fraudulent transactions.

The fraud risk associated with the archetype cluster distribution may represent one of few methods to obtain risks associated with CNP transactions. Merchants may accumulate a database of all the customer transactions occurring at that merchant. The frequency of purchases made online by a customer may assist in determining whether the transaction is of high risk. If a customer regularly makes purchases at a merchant, the risk associated with the customer may be lower; on the contrary the risk is higher if a customer made purchase rarely or infrequently. Such anomalous or fraudulent behaviors may be detected using frequent-behavior sorted list method (BLIST). The BLIST technology in accordance with some implementations is described in US patent 2010/0228580, the contents of which are incorporated by reference herein for all purposes and are described briefly below. Those skilled in the art may not find it difficult to find other factors which may be related to occurrence of fraud such as sudden shipping location change or synchronized frequent transactions from a small region etc. to determine the fraud risks associated with CNP transactions.

Merchants conducting CNP transactions may have a wider range of customers around the world than the card-present transactions which generally occur in some regions and some times of a day. But in the meanwhile the CNP transactions entail a large number of likely fraudsters all over the world in any time. More and more businesses move to online stores, however the fraud rates are seen much higher than those card-present transactions. To alleviate the incurred fraud loss, the methods described may be adopted. As the first step, on the global scale, the archetypes of all customers may be obtained based on their spending patterns including transaction time, amount, MCC, location, merchant etc. The LDA model is utilized to generate the PAN-archetype probability matrix from which the customers are labeled as one of the archetypes or more generally as a distribution across all archetypes. Secondly, a merchant may obtain the global designation of all customers and use that to build an archetype distribution based on the merchant's customer database. The correlation between fraud rates and archetype percentage is obtained from the merchant database. New transactions are evaluated first by looking up the archetype in the merchant dataset and then by determining the fraud rate in the archetype. The risk associated with the archetype designation may be represented as Rₐ. This fraud risk is obtained from the distribution of archetypes and may be evolving once the LDA model is retrained with new transactions. Thus the distribution is data-driven dynamic entity to reflect the current trend.

On the other hand, the frequency of purchases is an important indicator of whether the transactions are legitimate or fraudulent. The BLIST model obtains frequency information on entities in transaction data, and converts frequency information to a frequency variable, predicting whether an activity is fraudulent in response to the frequency variable using a frequency table and associating a fraud risk associated with common entries. The transaction details are compared with the frequency table (or recurrence list) for typical good and fraudulent activity in the different merchant-specific archetype clusters. The intuition is rareness of transaction details imply increased risk for non-fraudulent customer clusters while commonness of transactions details imply increased risk for fraudulent customers for fraudulent customer clusters. The risk associated with the transaction frequency may be determined a priori from the merchant's dataset with existing transaction data and the risk for a new transaction may be obtained by looking up the frequency table and denoted as R_{f}.

The two fraud risks, archetype-related risk Rₐ and frequency-related R_{f} may be mingled to form a single risk indicator by weighting the two risks, for example, the total fraud risk R is represented as:

log odds(R)=a*log odds(Rₐ)+(1−a)*log odds(R_{f})

where a (0<a<=1) and (1−a) represent two coefficients weighting on the two risks in log odds space. Such aggregated measure of risk may combine the benefits from the two important risk factors: archetype-related and frequency-day (BLIST model) related. If the risk obtained for a transaction exceeds some preset threshold, the transaction may be likely a fraudulent transaction and the transaction may be placed under further investigation.

In addition in the case without tags, the archetype cluster distribution is also vital for merchants to characterize behavior of customers transacting at the merchants. By sharing the archetype vectors for each PAN between card issuers or processors, an individual merchant may cluster its own customers into different groups. For the existing customers the cluster population may serve as a good indicator of the potential risk with the transactions. It may have a lower fraud risk if the customer falls into one of the main modes and may pose a high risk if falling onto a sparse cluster. For the new customers that never transact at the merchant, the archetype vector may be obtained and transferred from the global distribution at the card issuer level and the distance to the existing clusters at the merchant may provide good estimations of potential risks. That is if the transaction archetype vector point falls onto a cluster, indicating that the transaction is close to those in the cluster and may share similar characteristics with those in this cluster. On the other hand if the vector point stays away from any cluster, the closest cluster may be used to characterize such a transaction and the potential risk may be also estimated.

When using the LDA model in scoring mode, the archetype loadings are updated in real-time within the transaction profile of the entity (e.g., customer, account or device). An algorithm to accomplish this is included in U.S. patent application Ser. No. 14/566,545, entitled “Collaborative Profile-Based Detection Of Behavioral Anomalies And Change-Points,” the contents of which are incorporated herein by reference for all purposes, and which supports the use of the analytic techniques within to allow for profiling of transaction details and utilizing real-time collaborative profiling to determine archetypes based on streaming data. The reference discusses a method for recursively updating the archetypes in an entity's transaction profile as data streams into a scoring model. Using these techniques allows a set of real-time profile-based archetypes to be continually maintained/refined as real-time transactions is monitored at the issuer site. This real-time archetype update is important as it allows the archetype distribution associated with the customer to adjust based on real-time changes in behavior such as take-over by a fraudster or change in purchase behaviors.

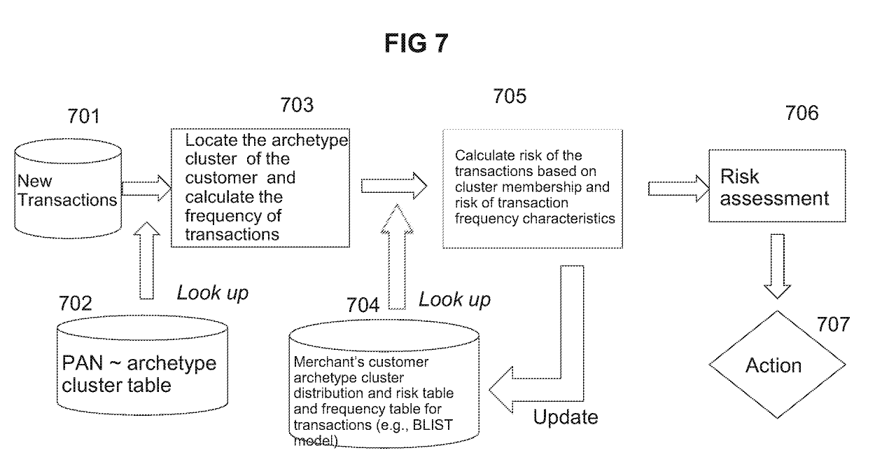

The above methods may be implemented into a system to assess risks associated with transactions. FIG. 7 shows a schematic block diagram of a preferred embodiment of a data processing system in accordance with the invention. The data processing system has inputs 701 from new transactions. One of the characteristics of transactions is the PAN and PAN corresponds to an archetype or archetype distribution from the PAN-archetype table 702 built from the LDA dataset model. The archetypes of the transactions are then obtained and in the meanwhile the intervals of transactions may be calculated as well from the customer database. This step is represented in 703. The archetype information is utilized to compare with the archetype distribution to determine the risk Rₐ which uses the relationship between fraud rate and archetype percentage in block 704 associated with the merchant and the derived archetype clusters for transactions specifically at that merchant. In general the higher risk is associated with lower archetype cluster proportions while lower risk is associated with higher archetype cluster proportion (as seen in FIG. 6). On the other hand the frequency of the transactions by the same customer may be used to determine the transaction risk R_{f}. The frequency table built using BLIST model (obtained from the entire dataset) in 704 may be used to predict the fraud rates for new transactions. It is important to note that this could be repeated transactions for the customer or a BLIST across all customer transactions to determine commonly risky or common amounts or items purchased within an archetype cluster.

The new transactions may be fed back to the archetype percentage distribution table and frequency table (in BLIST model) to update those tables to accommodate the changes dynamically. The two types of risks are calculated in block 705 for new transactions and output to 706 for risk assessment. The total risk may be a sum of weighted contribution from two risk factors. Those skilled in the art may adopt different ways to calculate the total risk such as using the mean value or maximum value of the two etc.

The total risk value obtain in 706 may be utilized to make a decision on the transaction. If the total risk exceeds some preset threshold, the transaction may be likely fraudulent, thus, the transaction may be placed under further review or investigation. If the total risk is small, the transaction may go through and the merchant may proceed to ship the merchandise to customers. The action after the risk evaluation is performed in 707 for each new transaction. Hence using the inventive methods described above, online merchants may reduce the number of the cases that need to review by a way of obtaining the total risk associated with transactions, thus may reduce the operational cost of business in practice by utilizing concise transaction history information for cards across many merchants in the form of the archetype distribution at the time the merchant transaction occurs.

According to one or more embodiments of the present disclosure, new transactions are evaluated by the above data processing system for fraud detection. In the dataset to be employed to build a LDA model, each transaction is characterized by PAN, transaction date, time, location, merchant and MCC etc. and those quantities may be utilized directly as raw variables or indirectly by derived variables. The execution of the LDA training results in a general PAN-archetype probability matrix. The probability matrix may be utilized to label customers into different archetypes. One way is to assign the archetype of the maximum probability to the customer. In this manner, the new attributes of a transaction may be added together with the existing attributes such as date, time, location etc.

For merchants in the dataset, the distribution of archetypes may be obtained for individual merchants. That is each merchant has a list of archetype distributions in the customer dataset. The archetype distribution reveals a relationship with the fraudulent behavior of customers in different archetypes and different archetype distributions. According to one embodiment of the present invention, the merchant may utilize the relationship as a risk measure of new transaction. On the other hand the frequency of transactions for the same customer may be indicative of the fraudulent behaviors as well using the BLIST model according to some embodiments of the invention. Combining the two aspects of the risk, the merchant may determine if a new transaction is fraudulent or if further investigation is needed.

For online merchants, the transactions may be card-not-present only and the risks are noted to be much larger than card-present transactions. Reducing the risk of transactions for CNP transactions is crucial for online merchants to reduce monetary loss incurred by the fraudsters worldwide. The above methods apply perfectly to the CNP transactions in two folds: 1) the online merchant may have accumulated customer base so that the above analysis method may be utilized for risk assessment; 2) the analysis method might take some time to finalize the risk assessment. But due to the nature of CNP transactions the shipping time is usually lagged after the order is received. In such a scenario the loss may be alleviated if the further investigation turns out to be positive (fraudulent purchase). Certainly the method and system to detect fraud and outliers may be not limited to the CNP transactions, actually may be applied to other fields where the LDA models are applicable.

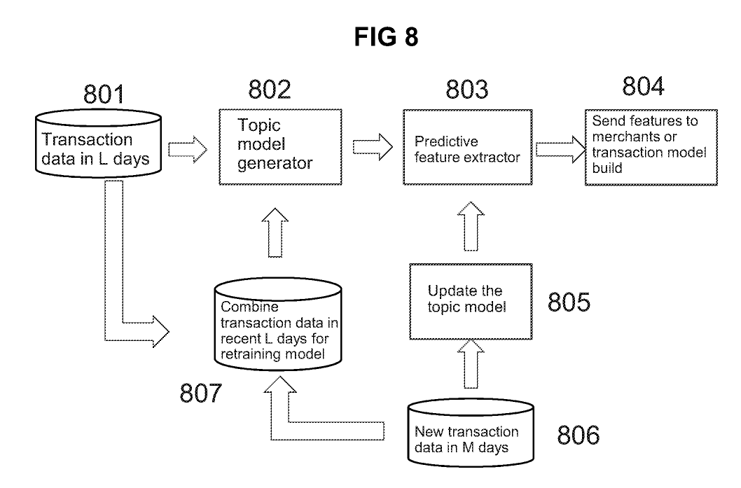

The system may be implemented for online operation so that new CNP transactions are faster to participate into the model, resulting in improved predictive capability. While training a topic model such as LDA model proves expensive and time-consuming on a full scale, the existing topic model can be updated with new transactions without retraining the entire model. FIG. 8 illustrates a schematic diagram of such an online process. A topic model 802 is trained with transactions in a period of L days in 801 and thus the topic-document probability matrix may be obtained. L may be equal to 30 days so that monthly transactions may be utilized for the topic model training. As described above, proper selection of the document and word may be made prior to the execution of LDA. After the topic model is trained, the archetype distribution may be obtained in 803 for merchants and the frequency table may be built as well. In case the tags are available the fraud rates may be calculated as well for each archetype. These features extracted from the topic model may be transported to merchants for evaluating fraud risks for incoming new transactions or may be combined together with other transaction attributes to train a fraud detection model in block 804.

With new transaction data available after the topic model us built, the topic model may need to be updated or retrained to accommodate new characteristics in new transaction data. Generally the retraining a topic model is expensive but updating a topic model may be performed online. For this purpose new transaction data are accumulated in M days in 806. M may be shorter than L (i.e., M<L). For example, L=30 days while M=1 week=7 days, that indicates that the topic model may be updated weekly in 805. Once the model gets updated, the features may be extracted again in the same manner described above and the obtained features are sent to merchants to update the previous features or are sent to build new transaction model. In some cases customers would be completely rescored based on the new archetype word probability matrix, in other situations the shift is subtle and the new probability matrix is used with the existing recursively estimated archetype distributions, as described in U.S. patent application Ser. No. 14/566,545, entitled “Collaborative Profile-Based Detection Of Behavioral Anomalies And Change-Points,” the contents of which are hereby incorporated by reference for all purposes. The cycle may repeat so that the characteristics in new transactions may be captured and translated into new model features for merchants or model build.

Online purchases have grown rapidly in recent years and may catch up to 35% of the overall transactions due to the factors like convenience, wider selections, etc. For online merchants it is known that fraud rate is higher than in-store (card-present) transactions. Intelligently mining the behaviors of the customer spending behaviors certainly benefits merchants in reducing potential fraudulent loss and expanding the customer base. The inventive method presented above suits such a purpose to understand customer's spending behaviors. The method involves a few steps in the procedure: 1) it generates the overall customer spending patterns on the global level, i.e., card-issuer level or processor level by virtue of a topic model like a LDA model; 2) it categorizes the cardholders into subsets based on the archetype vectors with a clustering algorithm like K-means; 3) the archetype cluster distributions and archetype vectors are thus shared down to merchants; 4) At merchants, the customers are mapped to individual archetype clusters globally and the modal distribution of archetypes in their customer database may serves as one indicator of fraudulent activity and also serve as a reference for accurate target marketing offers and other business strategy; 5) At merchants, the merchant can do their own K-means clustering of archetype vectors to have unique merchant-based archetype clusters for transacting customers vs. a global archetype clusters; 6) The risks of new transaction may be determined from the modal distribution, frequency of visits in merchants etc. The generated risks based on global archetype clusters and merchant specific archetype clusters serve as a base for merchants to approve the transaction or put the transaction under scrutiny. Due to the nature of the CNP transactions in which the shipping lags ordering, the transaction risk estimates from both the customer spending habits at the global level and the archetype cluster modal distribution at merchant level in the above stated method and system would aid merchants in better understanding customer transaction behaviors of their specific good and fraudulent customers and thus mitigate the loss of fraudulent activities. The method presented above can apply not only to CNP transactions but to other entity detection as well with variants in the case a topic model can be established.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method to detect fraudulent transactions comprising:
receiving, by a merchant transaction computer during a card-not-present (CNP) online transaction conducted over a communications network, data representing a new transaction from a customer's payment card,
associating, by the merchant transaction computer, the customer with an archetype distribution stored in an electronic database, the archetype distribution being generated by an archetype calculation engine based on past transactions across a plurality of merchants by the customer and customer attributes and computed by an issuer or processor of the customer's payment card;
generating, by the archetype calculation engine, a topic model based on one or more words and/or one or more documents selected from the data representing the new transaction and the past transactions, the topic model representing a similarity of the words and/or documents of the new transaction with words and/or documents in the past transactions represented by the archetypes;
generating, by the archetype calculation engine, archetype clusters based on the archetype distribution vectors for each document upon execution of a topic model, the archetype clusters representing a similarity of documents in the archetype space based on past transactions by the customer and customer attributes;
associating, by the merchant transaction computer, the customer with an archetype cluster generated by the archetype cluster calculation engine based on data representing the past transactions from the customer or one or more other customers, the archetype cluster representing a distribution of a probability of attributes related to each of the past transactions at the merchant;
locating, by the merchant transaction computer from the electronic database, an archetype distribution vector and archetype cluster generated by the archetype calculation engine based on data representing the past transactions from the customer or one or more other customers, the archetype cluster representing a distribution of a probability of attributes related to each of the past transactions at a multitude merchants, the archetype distribution vector representing the current archetype distribution of the customer's transactions across a multitude of merchants; and
generating, by the merchant transaction computer in near real time to the CNP transaction, a score representing a likelihood of fraud associated with the new transaction based on the calculated transaction risks associated with global archetype cluster membership, merchant-specific archetype cluster membership, and recurrence list positions of transaction details.

2. The method in accordance with claim 1, further comprising:
calculating, by the merchant transaction computer, a merchant-specific archetype cluster based on a history of merchant-transactions and associated archetype distribution vectors at time of merchant-transactions, the merchant-specific archetype cluster representing typical non-fraudulent and fraudulent customers grouped into merchant-specific archetype clusters based on merchant-specific transactions.

3. The method in accordance with claim 1, wherein the archetype clusters are generated using a K-means clustering algorithm in the multi-dimensional archetype space, subsetting customers into a plurality of archetype clusters.

4. The method in accordance with claim 2, further comprising:
calculating, by the merchant transaction computer, a risk associated with a global archetype cluster allocation for a customer based on the customer's archetype distribution vector associated with a plurality of merchant transactions.

5. The method in accordance with claim 4, wherein the risk represents a difference between the archetype distribution associated with the new transaction to the archetype distribution associated with the archetype cluster.

6. The method in accordance with claim 4, further comprising calculating, by the merchant transaction computer, a position of the customer's archetype distribution vector based on the merchant-specific archetype clusters.

7. The method in accordance with claim 6, wherein calculating the position includes associating a risk of the customer's transaction based on which merchant-specific archetype clusters the customer's archetype distribution vector is most associated.

8. The method in accordance with claim 4, further comprising calculating, by the merchant transaction computer, a position of the customer's transaction details with respect to a recurrence list associated with typical non-fraudulent and fraudulent activity associated with merchant transactions in the different merchant-specific archetype clusters.

9. The method in accordance with claim 8, wherein a rareness of transaction details imply an increased risk for non-fraud customer clusters, while a commonness of transactions details imply an increased risk for fraudulent customers for fraudulent customer clusters.

10. A system for detecting fraudulent transactions comprising:
at least one programmable processor; and
a machine-readable medium storing instructions that, when executed by the at least one processor, cause the at least one programmable processor to perform operations comprising:
receiving, during a card-not-present (CNP) online transaction conducted over a communications network, data representing a new transaction from a customer's payment card,
associating the customer with an archetype distribution stored in an electronic database, the archetype distribution being generated by an archetype calculation engine based on past transactions across a plurality of merchants by the customer and customer attributes and computed by an issuer or processor of the customer's payment card;
generating a topic model based on one or more words and/or one or more documents selected from the data representing the new transaction and the past transactions, the topic model representing a similarity of the words and/or documents of the new transaction with words and/or documents in the past transactions represented by the archetypes;
generating archetype clusters based on the archetype distribution vectors for each document upon execution of a topic model, the archetype clusters representing a similarity of documents in the archetype space based on past transactions by the customer and customer attributes;
associating the customer with an archetype cluster generated by the archetype cluster calculation engine based on data representing the past transactions from the customer or one or more other customers, the archetype cluster representing a distribution of a probability of attributes related to each of the past transactions at the merchant;
locating, from the electronic database, an archetype distribution vector and archetype cluster generated by the archetype calculation engine based on data representing the past transactions from the customer or one or more other customers, the archetype cluster representing a distribution of a probability of attributes related to each of the past transactions at a multitude merchants, the archetype distribution vector representing the current archetype distribution of the customer's transactions across a multitude of merchants; and
generating, in near real time to the CNP transaction, a score representing a likelihood of fraud associated with the new transaction based on the calculated transaction risks associated with global archetype cluster membership, merchant-specific archetype cluster membership, and recurrence list positions of transaction details.

11. The system in accordance with claim 10, wherein the operations performed by the at least one programmable processor further comprise:
calculating a merchant-specific archetype cluster based on a history of merchant-transactions and associated archetype distribution vectors at time of merchant-transactions, the merchant-specific archetype cluster representing typical non-fraudulent and fraudulent customers grouped into merchant-specific archetype clusters based on merchant-specific transactions.

12. The system in accordance with claim 10, wherein the archetype clusters are generated using a K-means clustering algorithm in the multi-dimensional archetype space, subsetting customers into a plurality of archetype clusters.

13. The system in accordance with claim 11, wherein the operations performed by the at least one programmable processor further comprise:
calculating a risk associated with a global archetype cluster allocation for a customer based on the customer's archetype distribution vector associated with a plurality of merchant transactions.

14. The system in accordance with claim 13, wherein the risk represents a difference between the archetype distribution associated with the new transaction to the archetype distribution associated with the archetype cluster.

15. The system in accordance with claim 13, wherein the operations performed by the at least one programmable processor further comprise calculating a position of the customer's archetype distribution vector based on the merchant-specific archetype clusters.

16. The system in accordance with claim 15, wherein calculating the position includes associating a risk of the customer's transaction based on which merchant-specific archetype clusters the customer's archetype distribution vector is most associated.

17. The system in accordance with claim 13, wherein the operations performed by the at least one programmable processor further comprise calculating a position of the customer's transaction details with respect to a recurrence list associated with typical non-fraudulent and fraudulent activity associated with merchant transactions in the different merchant-specific archetype clusters.

18. The system in accordance with claim 17, wherein a rareness of transaction details imply an increased risk for non-fraud customer clusters, while a commonness of transactions details imply an increased risk for fraudulent customers for fraudulent customer clusters.
